(19) United States
(12) Patent Application Publication
(10) Pub. No.: US 2006/0173944 A1
(43) Pub. Date: Aug. 3, 2006

(54) Exponential function generator

(75) Inventors: Han-seung Lee, Ansan-si (KR); Jeongwook Koh, Seoul (KR); Jung-eun Lee, Seongnam-si (KR); Hoang Quoc Duong, Daejeon (KR); Sang-gug Lee, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/338,747

(22) Filed: Jan. 25, 2006

(30) Foreign Application Priority Data
Feb. 1, 2005 (KR) 2005-0009180

(51) Int. Cl. G06F 1/02

(52) U.S. Cl. 708/270

(57) ABSTRACT

An exponential function generator for generating an exponential generator to realize a linear region of about 60 dB required for the an ultra wide band system (UWB). Since the exponential function generator is implemented in a form of complementary metal oxide semiconductor fabrication (CMOS), compactness and operation control of the exponential function generator can be facilitated.

### CROSS-REFERENCE TO RELATED APPLICATIONS

This application claims priority under 35 U.S.C. § 119 (a) from Korean Patent Application No. 2005-9180 filed on Feb. 1, 2005 in the Korean Intellectual Property Office, the entire disclosure of which is incorporated herein by reference.

### BACKGROUND OF THE INVENTION

1. Field of The Invention

Apparatuses consistent with the present invention relate to exponential function generation. More particularly, the present invention relates to an exponential function generator for efficiently generating an exponential function in a communication system where low power consumption and compactness are required.

2. Description of The Related Art

Terminals establishing a mobile communication system such as ultra wide band (UWB) systems, require low power consumption and compactness. A terminal (transmitting terminal) in a typical mobile communication system transmits data with low power to a nearby receiving terminal, and transmits data with high power to a distant receiving terminal. As such, for the efficient data communication according to a distance therebetween, the transmitting terminal and the receiving terminal need a circuitry having a gain of an exponential function.

A conventional exponential function generation method is disclosed in U.S. Pat. No. 5,880,631, which describes how to use a parasitic bipolar junction transistor (BJT) in a complementary metal oxide semiconductor (CMOS) fabrication. The BJT, of which voltage and current have characteristics of the exponential function, does not require a separate exponential function generator. However, disadvantageously, the parasitic BJT is subject to poor frequency characteristics, and is not suitable to the wide band circuitry. Specifically, the frequency range of the parasitic BJT is 10 MHz, whereas the frequency range required for the wide band circuitry is 264 MHz.

“A Low-Voltage Low-Power Wide-Range CMOS Variable Gain Amplifier” by Motamed A et al. approximately expresses the exponential function as Equation 1.

$${ⅇ}^{( 2 ny )} = {ⅇ}^{{( 2 y )}^{n}} = {( \frac{{ⅇ}^{y}}{{ⅇ}^{- y}} )}^{n} \approx {( \frac{1 + y}{1 - y} )}^{n} \qquad [ Equation 1 ]$$

A linear region (current to gain) of about 40 dB can be acquired based on Equation 1.

“Variable Gain Amplifiers based on a New Approximation Method to Realize the Exponential Function” by Soliman A. M and Abdelfattah K. M approximately expresses the exponential function as Equation 2.

$${ⅇ}^{X} = \frac{{ⅇ}^{aX}}{{ⅇ}^{( - ( 1 - a ) X )}} \approx \frac{1 + aX}{1 - ( 1 - a ) X} \qquad [ Equation 2 ]$$

Based on Equation 2, a linear region (current to gain) of about 50 dB can be acquired.

FIG. 1 depicts characteristics of a conventional circuit designed for an exponential function which is approximately expressed. In FIG. 1, the horizontal axis indicates a current or a voltage, and a vertical axis indicates a gain. Equation 3 approximately expresses the conventional exponential function (shown as line (1)).
e^{ax}≈1+(ax)/1!+(ax)²/2!=[1+(1+ax)²]/2 [Equation 3]

FIG. 1 shows another equation approximately expressing the conventional exponential function (shown as line (2)).
e^{ax}=[1+(ax)/2]/(1−ax/2)] [Equation 4]

Particularly, FIG. 1 shows a graph when a is 0.1 in Equations 3 and 4. As shown in FIG. 1, the linear region obtainable based on Equations 3 and 4 are about 20 dB and 40 dB. However, for the efficient support for the UWB communication system, each terminal needs to assure the linear region of about 60 dB.

### SUMMARY OF THE INVENTION

The present invention has been provided to address the above-mentioned and other problems and disadvantages occurring in the conventional arrangement, and an aspect of the present invention provides an exponential function generator for obtaining a linear region of about 60 dB at each terminal to efficiently support an ultra wide band (UWB) system.

Another aspect of the present invention provides an exponential function generator for performing a rapid control and generating a compactible exponential function for the efficient support for the UWB communication system.

To achieve the above aspects of the present invention, an exponential function generator is provided for realizing an equation which approximately expresses an exponential function:

$${I}_{out} = {ⅇ}^{{aI}_{in}} \approx \frac{k + {( 1 + {aI}_{in} \text{/} 2 )}^{2}}{k + {( 1 - {aI}_{in} \text{/} 2 )}^{2}}$$

where Iₒᵤₜ denotes an output current, Iᵢₙ denotes an input current, and k is a real number greater than zero.

### BRIEF DESCRIPTION OF THE DRAWING FIGURES

These and/or other aspects and advantages of the invention will become apparent and more readily appreciated from the following description of non-limiting exemplary embodiments, taken in conjunction with the accompanying drawing figures of which:

FIG. 1 is a graph showing characteristics of a circuit which approximately expresses a conventional exponential function;

FIG. 2 is a circuit for realizing a numerator of an approximation expression of an exponential function according to a non-limiting embodiment of the present invention;

FIG. 3 is a circuit for realizing a denominator of an approximation expression of an exponential function according to a non-limiting embodiment of the present invention;

FIG. 4 is a circuit for dividing a current which is input to the circuits of FIGS. 2 and 3;

FIG. 5 is a graph showing characteristics of the circuit of the exponential approximation function according to a non-limiting embodiment of the present invention; and

FIG. 6 is a graph showing a difference between the present method and the conventional method.

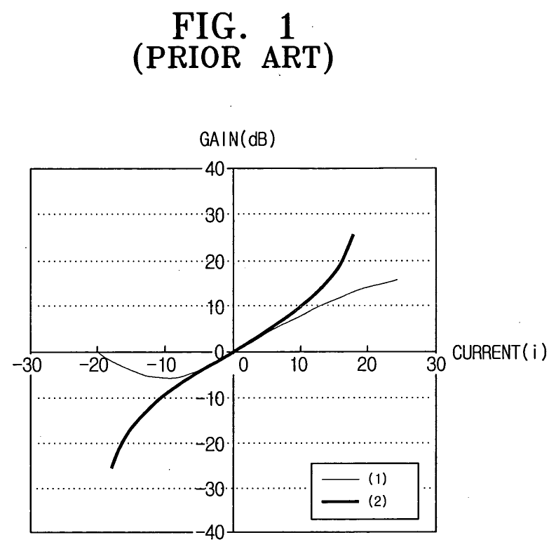

### DETAILED DESCRIPTION OF THE EMBODIMENTS

Certain non-limiting exemplary embodiments of the present invention will now be described in greater detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

Hereafter, descriptions are made on a method for realizing a circuit which can assure a linear region of about 60 dB in reference to the attached drawings.

Equation 5 shows an exponential function which can assure a linear region of about 60 dB according to a non-limiting embodiment of the present invention.

$${ⅇ}^{ax} = \frac{{ⅇ}^{ax / 2}}{{ⅇ}^{- ax / 2}} \approx \frac{k + {( 1 + ax \text{/} 2 )}^{2}}{k + {( 1 - ax \text{/} 2 )}^{2}} \qquad [ Equation 5 ]$$

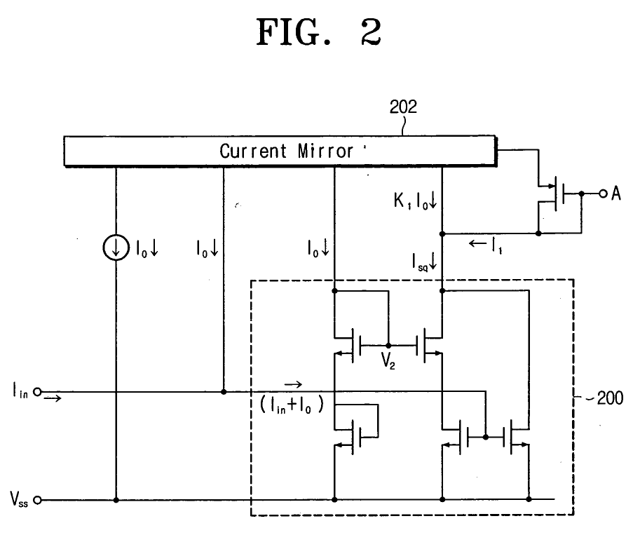

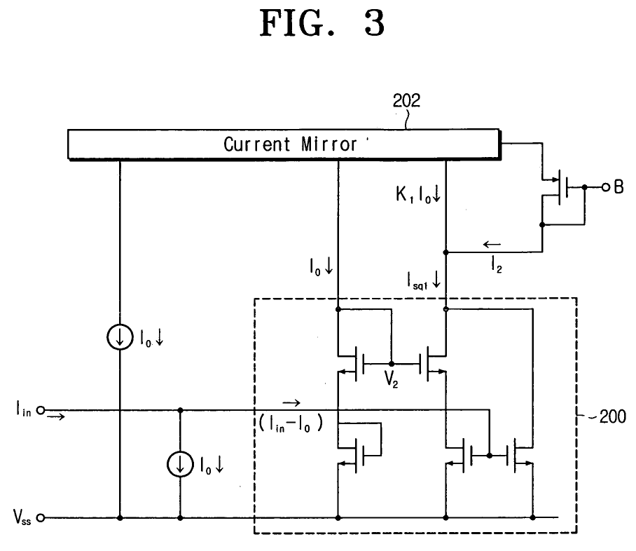

A circuit for generating an exponential function is explained now in reference to FIG. 2 and FIG. 3. FIG. 2 depicts a circuit for the generation of a numerator of Equation 5.

FIG. 2 shows a current mirror 202 and a current squaring block 200 for generating a current of the numerator according to a non-limiting embodiment of the present invention. The current mirror 202 repeatedly generates a current in the same amount. As can be seen from FIG. 2, the current mirror 202 generates three currents. The current squaring block 200 generates the numerator of Equation 5. In the following, the method of generating the numerator of the exponential function is explained in detail based on Equation 6 and Equation 7.

$$\begin{matrix}{I}_{sq} = 2 {I}_{0} + {( {I}_{in} + {I}_{0} )}^{2} / 8 {I}_{0} & [ Equation 6 ] \\ {I}_{1} = {I}_{sq} - {k}_{1} {I}_{0} = \frac{{I}_{0 }}{8} [ 8 ( 2 - {k}_{1} ) + {( 1 + \frac{{I}_{in}}{{I}_{0}} )}^{2} ] & [ Equation 7 ]\end{matrix}$$

where k₁ is a material constant of a complementary metal oxide semiconductor (CMOS) configuring the current mirror 202.

It is noted that Equation 7 has the same numerator as in Equation 5.

FIG. 3 depicts a current mirror 202 and a current squaring block 200 for generating a current of the denominator according to an embodiment of the present invention. The current mirror 202 repeatedly generates the current in the same amount. As shown in FIG. 3, the current mirror 202 generates two currents. The current of (Iᵢₙ+I₀) is input to the current squaring block 200 in FIG. 2, whereas the current of (Iᵢₙ−I₀) is input to the current squaring block 200 in FIG. 3. The current squaring block 200 generates the current of the denominator in Equation 5. The method of generating the numerator of the exponential function is now explained in detail based on Equation 8 and Equation 9.

$$\begin{matrix}{I}_{sq 1} = 2 {I}_{0} + {( {I}_{in} - {I}_{0} )}^{2} \text{/} 8 {I}_{0} & [ Equation 8 ] \\ {I}_{2} = {I}_{sq 1} - {k}_{1} {I}_{0} = \frac{{I}_{0 }}{8} [ 8 ( 2 - {k}_{1} ) + {( 1 - \frac{{I}_{in}}{{I}_{0}} )}^{2} ] & [ Equation 9 ]\end{matrix}$$

It can be seen that Equation 9 has the same denominator as in Equation 3.

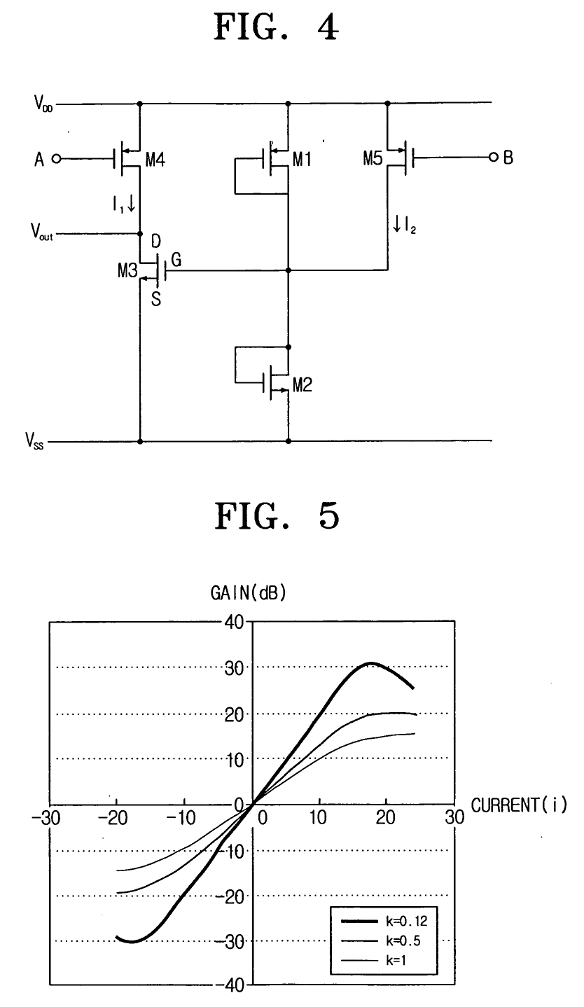

FIG. 4 depicts a circuit for dividing the current in FIG. 2 and FIG. 3 according to a non-limiting embodiment of the present invention. Particularly, FIG. 4 shows the circuit for dividing I₁ input to the circuit of FIG. 2 and I₂ input to the circuit of FIG. 3.

Equation 10 shows a gate voltage of M3.

$${V}_{G3} = \begin{matrix}\frac{{V}_{DD} - \vert {V}_{THp} \vert + {V}_{THn}}{2} + \\ \frac{{I}_{2 }}{K ( {V}_{DD} - \vert {V}_{THp} \vert - {V}_{THn} )}\end{matrix} \qquad [ Equation 10 ]$$

Equation 11 shows a resistance between a drain D and a source S of M3. K denotes a material constant. Note that Equation 11 shows the resistance when M3 operates in the linear region, among the saturation region and the linear region.

$${R}_{DS3} \approx \frac{1}{{K}_{3} ( {V}_{G3} - {V}_{THn}} ) \qquad [ Equation 11 ]$$

When V_{SS} is 0[v], V_{DS3} equals Vₒᵤₜ. Equation 12 shows Vₒᵤₜ of FIG. 4.
Vₒᵤₜ=R_{DS3}×I₁ [Equation 12]

Equation 13 expresses Equation 12 using Equation 7, Equation 9, and Equation 11.

$${V}_{out} \approx M \frac{K + {( 1 + \frac{{I}_{in}}{{I}_{0}} )}^{2}}{K + {( 1 - \frac{{I}_{in}}{{I}_{0}} )}^{2}} \qquad [ Equation 13 ]$$

As mentioned above, it can be seen that Equation 13 expresses the same formula as the exponential function according to a non-limiting embodiment of the present invention.

FIG. 5 shows a gain with respect to the current according to k in Equation 5 which expresses the exponential function according to a non-limiting embodiment of the present invention. Specifically, in FIG. 5, the horizontal axis indicates the current i (mA) and the vertical axis indicates the gain dB. FIG. 5 particularly shows the graph when a is 0.1. As shown in FIG. 5, the smaller k is, the more the linear region is extended, and the greater k is, the more the linear region is reduced. Although the horizontal axis indicates the current in FIG. 5 for the understanding, the same results can be obtained with the horizontal axis indicating the voltage.

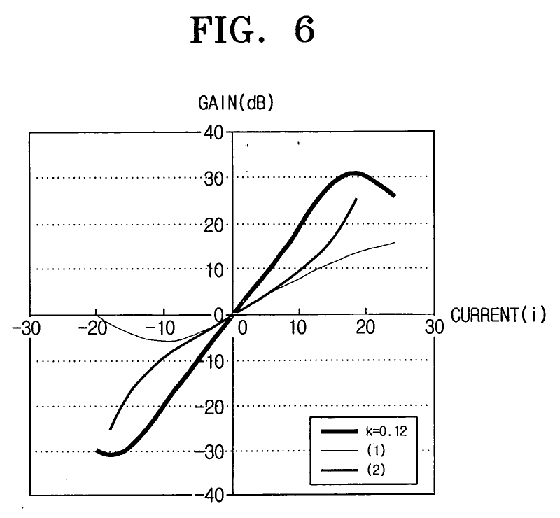

FIG. 6 is a graph for comparing the exponential function according to a non-limiting embodiment of the present invention with the exponential functions of the related art. As shown in FIG. 6, the present exponential function has the linear region wider than the exponential functions of the related art. For instance, a linear region of the related art is about 12 dB (shown as line (1)) in Equation 3, and another linear region of the related art is about 15 dB (shown as line (2)) in Equation 4. By contrast, the linear region of the present invention is about 60 dB (shown as line k=0.12) in Equation 5.

As set forth above, the present invention suggests the method for approximately expressing the exponential function and the circuit for realizing the expression, and thus obtains the linear region of about 60 dB in the current (voltage)—gain graph. Furthermore, the present invention can realize the compactness and the rapid control in comparison to the conventional circuit for the exponential function by use of the parasitic BJT or CMOS.

While the present invention has been particularly shown and described with reference to non-limiting exemplary embodiments thereof, it will be understood by those skilled in the art that various changes in form and details may be made therein without departing from the spirit and scope of the invention as defined by the appended claims.

What is claimed is:

1. An exponential function generator for realizing a first equation which approximately expresses an exponential function:
$${I}_{out} = {ⅇ}^{{aI}_{in} } \approx \frac{k + {( 1 + {aI}_{in} \text{/} 2 )}^{2}}{k + {( 1 - {aI}_{in} \text{/} 2 )}^{2}}$$
where Iₒᵤₜ denotes an output current, Iᵢₙ denotes an input current, |aIᵢₙ|<<1, and k is a real number greater than zero.

2. The exponential function generator of claim 1, wherein a is 0.1.

3. The exponential function generator of claim 1, comprising:
a numerator realization section which realizes a numerator in the first equation;
a denominator realization section which realizes a denominator in the first equation; and
a current division section for dividing and providing a received current to the numerator realization section and the denominator realization section.

4. The exponential function generator of claim 3, wherein the numerator realization section comprises:
a current mirror which outputs at least one same current I₀; and
a current squaring block which receives the at least one same current from the current mirror, and a current I_{sq} which is generated by the input current Iᵢₙ based on a second equation:
I_{sq}=2I₀+(Iᵢₙ+I₀)²/8I₀.

5. The exponential function generator of claim 4, wherein the current squaring block receives a current I₁ which is a difference between the current I_{sq} and a current k₁I₀ input from the current mirror and is calculated based on a third equation:
$${I}_{1} = {I}_{sq} - {k}_{1} {I}_{0} = \frac{{I}_{0}}{8} [ 8 ( 2 - {k}_{1} ) + {( 1 + \frac{{I}_{in}}{{I}_{0}} )}^{2} ]$$
where k₁ is a material constant of a complementary metal oxide semiconductor (CMOS) configuring the current mirror.

6. The exponential function generator of claim 3, wherein the denominator realization section comprises:
a current mirror which outputs at least one same current I₀; and
a current squaring block which receives the at least one same current from the current mirror, and a current I_{sq1} which is generated by the input current Iᵢₙ based on a fourth equation:
I_{sq1}=2I₀+(Iᵢₙ−I₀)²/8I₀.

7. The exponential function generator of claim 6, wherein the current squaring block receives a current I₂ which is a difference between the current I_{sq1} and a current k₁I₀ input from the current mirror and is calculated based on a fifth equation:
$${I}_{2} = {I}_{sq 1} - {k}_{1} {I}_{ 0} = \frac{{I}_{0}}{8} [ 8 ( 2 - {k}_{1} ) + {( 1 - \frac{{I}_{in}}{{I}_{0}} )}^{2} ]$$
where k₁ is a material constant of a complementary metal oxide semiconductor (CMOS) configuring the current mirror.
